(19) United States
(12) Patent Application Publication
(10) Pub. No.: US 2026/0059304 A1
(43) Pub. Date: Feb. 26, 2026

(54) SECURE COMMUNICATION FOR UNMANNED AERIAL VEHICLE IN INTEGRATED ECOSYSTEM

(71) Applicant: Continental Automotive Technologies GmbH, Hannover (DE)

(72) Inventor: Ali Akbar Pammu, Singapore (SG)

(73) Assignee: Continental Automotive Technologies GmbH, Hannover (DE)

(21) Appl. No.: 19/106,181

(22) PCT Filed: Aug. 9, 2023
(86) PCT No.: PCT/EP2023/072110

§ 371 Date: Feb. 24, 2025

(30) Foreign Application Priority Data
Aug. 25, 2022 (GB) 2212347.5

(51) Int. Cl. H04W 12/0471; H04L 5/00; H04W 12/50; H04W 84/06

(52) U.S. Cl. CPC H04W 12/0471; H04L 5/0053; H04W 12/50; H04W 84/06

(57) ABSTRACT

A secured communication for an Unmanned Aerial Vehicle (UAV) is established. A user terminal receives a UAV battery charge level from the UAV in response to the user terminal's request to the UAV. Based on the UAV battery charge level and a threshold battery charge level received in the delivery response, the user terminal transmits the delivery response to the UAV. The UAV verifies a signature in the delivery response using a unique public key of a public and private key pair and transmits an acknowledgement for the delivery response to the user terminal upon verifying the signature. Subsequently, the user terminal, upon receiving the acknowledgement, generates and transmits a session key to the UAV for establishing a secure communication between the UAV and the server for transportation. The UAV establishes the secure communication with the server using the session key.

### CROSS-REFERENCE TO RELATED APPLICATIONS

The present application is a National Stage Application under 35 U.S.C. § 371 of International Patent Application No. PCT/EP2023/072110 filed on Aug. 9, 2023, and claims priority from Great Britain Patent Application No. 2212347.5 filed on Aug. 25, 2022, in the United Kingdom Intellectual Property Office, the disclosures of which are herein incorporated by reference in their entireties.

### TECHNICAL FIELD

The present subject matter is generally related to the field of Unmanned Aerial Vehicle (UAV), more particularly, but not exclusively, to a method, a user terminal, a server, and a UAV for establishing secure communication for the UAV in an integrated ecosystem.

### BACKGROUND

Unmanned Aerial Vehicle (UAV) has gained traction in recent years due to advantages such as on-demand delivery, unmanned monitoring capability, providing assistance in environmental conditions not suitable for human beings, and the like. As more and more UAVs start to ply aerial, security of the UAV becomes critical. As technology evolves at a rapid pace, the UAVs are vulnerable to security attacks such as configuration tampering in the UAV to bypass the permission to use public space, man-in-the middle attack, denial-of-service attack, and spoofing communication to the server of faking a UAV path.

The information disclosed in this background of the disclosure section is for enhancement of understanding of the general background of the invention and should not be taken as an acknowledgement or any form of suggestion that this information forms the prior art already known to a person skilled in the art.

### BRIEF SUMMARY

There is a need to overcome the above-mentioned problems related to security of the UAV.

In an embodiment, the present disclosure relates to a method performed by a user terminal for establishing a secured communication for an Unmanned Aerial Vehicle (UAV) in an integrated ecosystem. The method comprising transmitting a delivery request to a server and receiving a delivery response from the server in response to the delivery request. Thereafter, the method comprising verifying the delivery response using a unique public key of a public and private key pair and transmitting a request to the UAV to share a UAV battery charge level upon verification of the delivery response. Subsequently, the method comprising receiving the UAV battery charge level from the UAV and transmitting the delivery response to the UAV based on the UAV battery charge level and a threshold battery charge level received in the delivery response. The method comprising receiving an acknowledgement to the delivery response and generating a session key for establishing a secure communication between the UAV and the server for transportation upon receiving the acknowledgement. Lastly, the method comprising transmitting the session key to the UAV.

In another embodiment, the present disclosure relates to a user terminal for establishing a secured communication for an Unmanned Aerial Vehicle (UAV) in an integrated ecosystem. The user terminal comprising a processor and a memory communicatively coupled to the processor, wherein the memory stores processor executable instructions, which on execution, cause the processor to transmit a delivery request to a server and receive a delivery response from the server in response to the delivery request. Thereafter, the processor is configured to verify the delivery response using a unique public key of a public and private key pair and transmit a request to the UAV to share a UAV battery charge level upon verification of the delivery response. In the subsequent step, the processor is configured to receive the UAV battery charge level from the UAV and transmit the delivery response to the UAV based on the UAV battery charge level and a threshold battery charge level received in the delivery response. The processor is configured to receive an acknowledgement to the delivery response and generate a session key for establishing a secure communication between the UAV and the server for transportation upon receiving the acknowledgement. Lastly, the processor is configured to transmit the session key to the UAV.

In an embodiment, the present disclosure relates to a method performed by a server for establishing a secured communication for a UAV in an integrated ecosystem. The method comprising receiving a delivery request from a user terminal and verifying the delivery request with at least one of UAV-related information and user-related information stored in the server. Thereafter, the method comprising preparing a delivery response for the delivery request upon verification and encrypting the delivery response using a unique private key of a public and private key pair. Lastly, the method comprising transmitting the delivery response to the user terminal.

In another embodiment, the present disclosure relates to a server for establishing a secured communication for a UAV in an integrated ecosystem. The server comprising a processor and a memory communicatively coupled to the processor, wherein the memory stores processor executable instructions, which on execution, cause the processor to receive a delivery request from a user terminal and verify the delivery request with at least one of UAV-related information and user-related information stored in the server. Thereafter, the processor is configured to prepare a delivery response for the delivery request upon verification and encrypt the delivery response using a unique private key of a public and private key pair. Lastly, the processor is configured to transmit the delivery response to the user terminal.

In an embodiment, the present disclosure relates to a method performed by a UAV for establishing a secured communication for the UAV in an integrated ecosystem. The method comprising transmitting a UAV battery charge level to a user terminal upon receiving a request from the user terminal and receiving a delivery response from the user terminal. Thereafter, the method comprising verifying a signature in the delivery response using a unique public key of a public and private key pair and transmitting an acknowledgement to the delivery response upon verifying the signature. Lastly, the method comprising receiving a session key from the user terminal for establishing a secure communication between the UAV and a server for transportation.

In another embodiment, the present disclosure relates to a UAV for establishing a secured communication for the UAV in an integrated ecosystem. The UAV comprising a processor and a memory communicatively coupled to the processor, wherein the memory stores processor executable instructions, which on execution, cause the processor to transmit a UAV battery charge level to a user terminal upon receiving a request from the user terminal and receive a delivery response from the user terminal. Thereafter, the processor is configured to verify a signature in the delivery response using a unique public key of a public and private key pair and transmit an acknowledgement to the delivery response upon verifying the signature. Lastly, the processor is configured to receive a session key from the user terminal for establishing a secure communication between the UAV and a server for transportation.

Embodiments of the disclosure according to the above-mentioned methods, the user terminal, the server, and the UAV bring about several technical advantages.

In present disclosure, prior to establishing secure communication between a UAV and a server, communication including request and/or response exchanged between a user terminal, the server and the UAV is authenticated or verified using a public and private key pair unique to the user terminal, the server and the UAV. This approach ensures enhanced security to prevent configuration tampering in the UAV to bypass the permission to use public space and/or cyberattack such as man-in-the middle attack and denial-of-service attack.

The use of a session key from a user terminal for establishing a secure communication between a UAV and a server for transportation ensures that communication between the UAV and the server is aligned appropriately and securely with the parameters exchanged between the user terminal, the server, and the UAV. This approach ensures enhanced security (for secured communication) to prevent spoofing communication to the server of faking a UAV path.

The delivery response prepared by a server of the present disclosure ensures information or parameters such as a schedule of departure, an efficient path from a source location to a destination location, alternative routes from the source location to the destination location, an altitude of operation of the UAV, a threshold battery charge level or an amount of energy required to reach the destination location, a maximum and minimum speed of the UAV to reach from the source location to the destination location, a signature for verification by the UAV and a random number to permit a privilege access level request to operate in public spaces. This approach ensures UAV traffic (i.e., traffic management) is handled in an efficient and easy way (by concerned authorities).

The user terminal of the present disclosure performs transmitting a delivery response to a UAV based on the UAV battery charge level and a threshold battery charge level. This approach allows user terminal to ensure that the UAV battery charge level is at an appropriate level for the UAV to reach destination location and the UAV does not fail during the travel from a source location to the destination location due to lack of the UAV battery charge.

The user terminal, the server, and the UAV of the present disclosure work/co-ordinate together to form an integrated ecosystem that has secured communication in terms of encryption and/or verification (i.e., authentication), and efficient and easy way to manage UAV traffic (i.e., traffic management), thereby, making such ecosystem integrable with an ecosystem of smart city.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and together with the description, serve to explain the disclosed principles. In the figures, the left most digit(s) of a reference number identifies the figure in which the reference number first appears. The same numbers are used throughout the figures to reference like features and components. Some embodiments of system and/or methods in accordance with embodiments of the present subject matter are now described below, by way of example only, and with reference to the accompanying figures.

FIG. 1 illustrates an exemplary environment for establishing a secured communication for a UAV in an integrated ecosystem in accordance with some embodiments of the present disclosure.

FIG. 2 shows a detailed block diagram of a user terminal in accordance with some embodiments of the present disclosure.

FIG. 3 shows a detailed block diagram of a server in accordance with some embodiments of the present disclosure.

FIGS. 4a and 4b show detailed block diagrams of a UAV in accordance with some embodiments of the present disclosure.

FIG. 5a illustrates a flowchart showing a method for establishing a secured communication for a UAV in an integrated ecosystem performed by a user terminal in accordance with some embodiments of present disclosure.

FIG. 5b illustrates a flowchart showing a method for establishing a secured communication for a UAV in an integrated ecosystem performed by a server in accordance with some embodiments of present disclosure.

FIG. 5c illustrates a flowchart showing a method for establishing a secured communication for a UAV in an integrated ecosystem performed by a UAV in accordance with some embodiments of present disclosure.

FIG. 6 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Embodiment of the present disclosure provides a solution for establishing a secured communication for an Unmanned Aerial Vehicle (UAV). The present disclosure discloses a user terminal, a server and the UAV and their methods to establish the secured communication for the UAV. In brief, the server transmits a delivery response to the user terminal on receiving a delivery request from the user terminal. Thereafter, the user terminal receives a UAV battery charge level from the UAV in response to the user terminal's request to the UAV. Based on the UAV battery charge level and a threshold battery charge level received in the delivery response, the user terminal transmits the delivery response to the UAV. The UAV verifies a signature in the delivery response using a unique public key of a public and private key pair and transmits an acknowledgement for the delivery response to the user terminal upon verifying the signature. Subsequently, the user terminal, upon receiving the acknowledgement, generates and transmits a session key to the UAV for establishing the secure communication between the UAV and the server for transportation. Thereafter, the UAV establishes the secure communication with the server using the session key. This approach, which includes enhanced security measures using the public and private key pairs, ensures UAV traffic is handled in an efficient way, thereby, regulating the use of UAV in a safe and secured manner.

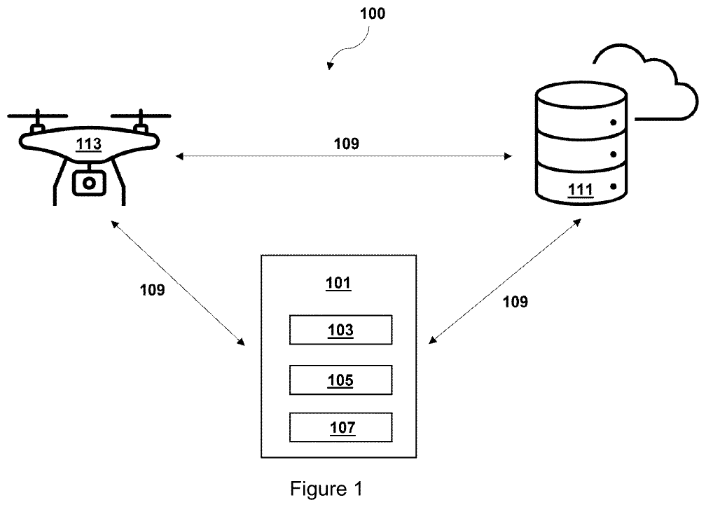

FIG. 1 illustrates an exemplary environment for establishing a secured communication for a UAV in an integrated ecosystem in accordance with some embodiments of the present disclosure.

As shown in the FIG. 1, the environment 100 includes a user terminal 101, a communication network 109, a server 111 and a UAV 113. The environment 100 (also, referred as an integrated ecosystem) encompassing the user terminal 101, the communication network 109, the server 111 and the UAV 113 work together to form an integrated ecosystem. The UAV 113 is an unmanned aerial vehicle such as aerial drone or any aerial vehicle. The UAV 113 can be adapted, but not limiting to, to transport one or more goods (or packages or cargos), or to transport one or more humans in case of an aerial taxi, or for observational purposes such as survey, monitoring, or for emergency aid during natural disaster, or during traffic accident that are not reachable by a land vehicle immediately, and the like. The UAV 113 may comprise a chamber. The chamber is configured to accommodate one or more goods (or packages or cargos) or one or more humans in case of the aerial taxi. The server 111 is a local server or a cloud server or a remote server. The server 111 may be operated by, but not limiting to, government-related agencies or any third party authorized (hereinafter, referred as concerned authority) to host the server 111. The user terminal 101 is, not limiting to, any of a mobile terminal, a computer system, a laptop, or a tablet computer. The user terminal 111 may include a UAV transportation application (i.e., an app) to initiate the process of transportation (using the UAV 113). In one embodiment, the UAV transportation application in the user terminal 111 can be integrated with any shopping application. The user terminal 101, the server 111 and the UAV 113 communicate among themselves using the communication network 109.

The communication network 109 may include, but is not limited to, an e-commerce network, a Peer to Peer (P2P) network, Local Area Network (LAN), Wide Area Network (WAN), wireless network (for example, using Wireless Application Protocol), Internet, Wi Fi, Bluetooth, cellular network, Aircraft Data Network (ARINC664), and the like.

The user terminal 101 communicates with the server 111 to receive a delivery response to its delivery request and with the UAV 113 to transmit the delivery response and a session key for establishing a secure communication between the UAV 113 and the server 111 for transportation. The user terminal 101 includes an I/O interface 103, a memory 105 and a processor 107. The I/O interface 103 is configured to communicate with the server 111 and the UAV 113. The I/O interface 103 may employ communication protocols/methods such as, without limitation, audio, analog, digital, monaural, Radio Corporation of America (RCA) connector, stereo, IEEE® 1394 high speed serial bus, serial bus, Universal Serial Bus (USB), infrared, Personal System/2 (PS/2) port, Bayonet Neill Concelman (BNC) connector, coaxial, component, composite, Digital Visual Interface (DVI), High Definition Multimedia Interface (HDMI®), Radio Frequency (RF) antennas, S Video, Video Graphics Array (VGA), IEEE® 802.11b/g/n/x, Bluetooth, cellular e.g., Code Division Multiple Access (CDMA), High Speed Packet Access (HSPA+), Global System for Mobile communications (GSM®), Long Term Evolution (LTE®), Worldwide interoperability for Microwave access (WiMax®), Aircraft Data Network (ARINC664), or the like.

The memory 105 is communicatively coupled to the processor 107 of the user terminal 101. The memory 105, also, stores processor instructions which cause the processor 107 to execute the instructions for establishing a secured communication for the UAV 113 in the integrated ecosystem.

The processor 107 includes at least one data processor for establishing a secured communication for the UAV 113 in the integrated ecosystem.

Hereafter, the operation of the user terminal 101, the server 111 and the UAV 113 for establishing a secured communication for the UAV 113 in the integrated ecosystem is described.

Prior to establishing a secured communication for the UAV 113, the server 111 generates a public and private key pair using a cryptographic algorithm. The cryptographic algorithm is, but not limiting to, a hash function-based algorithm, a symmetric key algorithm, or an asymmetric key algorithm, or quantum cryptographic algorithm. The public and private key pair includes a unique public key and a corresponding unique private key. The server 111 stores the unique private key of the public and private key pair securely in the server 111 and transmits the unique public key of the public and private key pair to the UAV 113 and the user terminal 101. On receiving the unique public key, the UAV 113 stores the unique public key securely in a root of trust module (described later), which is a part of UAV 113 memory, of the UAV 113. The UAV 113 uses the hash function-based algorithm to hash the unique public key. Thereafter, the UAV 113 stores the hashed public key in the root of trust module (also, referred as e-Fuse component). In addition to the unique public key, a UAV identifier (also, referred as UAV related information) and a diagnostic identifier are also stored in the root of trust module securely using the hash function-based algorithm. The root of trust module has write and read protections, which prevents any tampering. The UAV identifier is unique to each UAV and assigned during the manufacturing or production of the UAVs or prior to establishing a secured communication for the UAV 113 by the server 111. In one embodiment, the UAV 113 stores user related information that comprises at least one of name of a sender and/or a receiver and a license number of the UAV 113. The user terminal 101, also, stores the unique public key in the memory 105 on receiving the unique public key from the server 111.

Consider a situation where a user wants to transport a good or a package from a source location to a destination location using the UAV 113. The user uses the user terminal 101 to initiate the process of transportation (using the UAV 113). The user terminal 101 transmits a delivery request to the server 111. The delivery request comprises at least one of a privilege access level request to operate in public spaces, a UAV identifier, a destination location, user specific information and a type of cargo (a good or a package) to be delivered. The privilege access level refers to privilege access to use public space for the UAV 113 and/or to inform concerned authority to provide an efficient path to avoid UAV traffic. The type of cargo (the good or the package) refers to food from an online order/purchase, one or more documents, one or more items/products from the online order/purchase, one or more letters and the like. The user specific information includes at least one of name of a sender and/or a receiver, a license number of the UAV 113 and information (or description) about the cargo (a good or a package). The server 111 receives the delivery request from the user terminal 101. Thereafter, the server 111 verifies the delivery request with at least one of UAV related information and user related information stored in the server 111. In case of a delivery request verification failure due to mismatch of at least one the UAV identifier and the user specific information in the delivery request with at least one of the UAV related information and the user related information stored in the server 111, the server 111 may terminate present process by sending an authentication failure notification or an error message to the user terminal 101. Upon (successful) verification, the server 111 prepares a delivery response for the delivery request. The delivery response comprises at least one of a schedule of departure, an efficient path from a source location to a destination location, alternative routes from the source location to the destination location, an altitude of operation of the UAV 113, a threshold battery charge level or an amount of energy required to reach the destination location, a maximum and minimum speed of the UAV 113 to reach from the source location to the destination location, a signature for verification by the UAV 113 and a random number to permit a privilege access level request to operate in public spaces. The server 111 generates the random number. This random number is signed using the private key to generate the signature for verification by the UAV 113. The signature is sent together with the random number in the delivery response to the UAV 113 via the user terminal 101. The signature in the delivery response is verified by the UAV 113 using at least one of the random number and a unique public key of a public and private key pair stored in the UAV 113. After preparation of the delivery response, the server 111 encrypts the delivery response using the unique private key of the public and private key pair and transmits the delivery response to the user terminal 101. The user terminal 101 receives the delivery response from the server 111 in response to the delivery request. The user terminal 101 verifies the delivery response using the unique public key of the public and private key pair. In case of a delivery response verification failure due to mismatch of the unique public key of the user terminal 101 with the unique private of the public and private key pair of the server 111, the user terminal 101 may terminate present process by sending the authentication failure notification or the error message to the server 111. Upon (successful) verification of the delivery response, the user terminal 101 transmits a request to the UAV 113 to share a UAV battery charge level. Upon receiving the request from the user terminal 101, the UAV 113 transmits the UAV battery charge level to the user terminal 101. The user terminal 101 receives the UAV battery charge level from the UAV 113. Thereafter, based on the UAV battery charge level and a threshold battery charge level (or the amount of energy required to reach the destination location) received in the delivery response, the user terminal 101 transmits the delivery response to the UAV 113. In detail, the user terminal 101 compares the UAV 113 battery charge level and the threshold battery charge level (or the amount of energy required to reach the destination location) received in the delivery response. When the UAV battery charge level is higher than or equal to the threshold battery charge level (or the amount of energy required to reach the destination location), the user terminal 101 transmits the delivery response to the UAV 113. When the UAV battery charge level is lower than the threshold battery charge level (or the amount of energy required to reach the destination location), the user terminal 101 may terminate present process. The UAV 113 receives the delivery response from the user terminal 101. Thereafter, the UAV 113 verifies (or decrypts) a signature in the delivery response using at least one of the random number and the unique public key of the public and private key pair. In case of the delivery response verification failure due to mismatch of the signature in the delivery response with the unique public of the public and private key pair of the UAV 113, the UAV 113 may terminate present process by sending the authentication failure notification or the error message to the user terminal 101. Upon (successful) verification the signature, the UAV 113 transmits an acknowledgement to the delivery response to the user terminal 101. The user terminal 101 receives the acknowledgement to the delivery response from the UAV 113. Upon receiving the acknowledgement, the user terminal 101 generates a session key for establishing a secure communication between the UAV 113 and the server 111 for transportation. The session key is a unique key and is only generated once (i.e., not repeatable). The session key is generated by the user terminal 101 using a symmetric key algorithm, or an asymmetric key algorithm, or quantum cryptographic algorithm. The user terminal 101 transmits the session key to the UAV 113. The UAV 113 receives the session key from the user terminal 101 for establishing the secure communication between the UAV 113 and the server 111 for transportation. Thereafter, the UAV 113 establishes the secure communication with the server 111 using the session key.

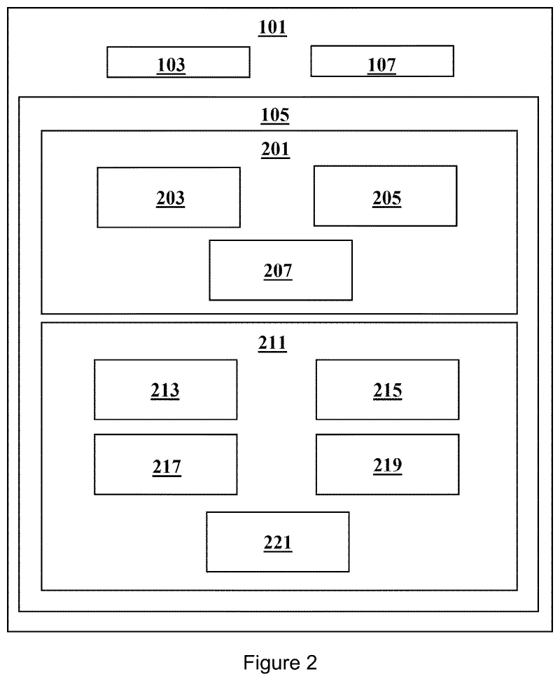

FIG. 2 shows a detailed block diagram of a user terminal in accordance with some embodiments of the present disclosure.

The user terminal 101, in addition to the I/O interface 103 and the processor 107 described above, includes data 201 and one or more modules 211, which are described herein in detail. In an embodiment, the data 201 is stored within the memory 105. The data 201 includes, for example, delivery response data 203, UAV battery charge level 205, and other data 207.

The delivery response data 203 includes delivery response, which comprises at least one of a schedule of departure, an efficient path from a source location to the destination location, alternative routes from the source location to the destination location, an altitude of operation of the UAV 113, the threshold battery charge level or an amount of energy required to reach the destination location, a maximum and minimum speed of the UAV 113 to reach from the source location to the destination location, a signature for verification by the UAV 113 and a random number to permit the privilege access level request to operate in public spaces.

The UAV battery charge level 205 includes UAV battery charge level received from the UAV 113.

The other data 207 may store data, including temporary data and temporary files, generated by one or more modules 211 for performing the various functions of the user terminal 101.

In an embodiment, the data 201 in the memory 105 is processed by the one or more modules 211 present within the memory 105 of the user terminal 101. In an embodiment, the one or more modules 211 may be implemented as dedicated hardware units. As used herein, the term module refers to an Application Specific Integrated Circuit (ASIC), an electronic circuit, a Field Programmable Gate Arrays (FPGA), Programmable System on Chip (PSoC), a combinational logic circuit, and/or other suitable components that provide the described functionality. In some implementations, the one or more modules 211 are communicatively coupled to the processor 107 for performing one or more functions of the user terminal 101. The one or more modules 211 when configured with the functionality defined in the present disclosure will result in a novel hardware.

In one implementation, the one or more modules 211 include, but are not limited to, a transceiver module 213, a verifying module 215, a generating module 217 and a comparing module 219. The one or more modules 211, also, include other modules 221 to perform various miscellaneous functionalities of the user terminal 101.

The transceiver module 213 acts as a transmitting module and a receiving module. The transceiver module 213 transmits and receives through the I/O interface 103. The transceiver module 213 transmits a delivery request to the server 111. In response to the delivery request, the transceiver module 213 receives a delivery response from the server 111. Upon verification of the delivery response, the transceiver module 213 transmits a request to the UAV 113 to share a UAV battery charge level. The transceiver module 213 receives the UAV battery charge level from the UAV 113. Based on the UAV battery charge level and a threshold battery charge level received in the delivery response, the transceiver module 213 transmits the delivery response to the UAV 113. The transceiver module 213 receives an acknowledgement to the delivery response. The transceiver module 213 transmits the session key to the UAV 113.

The verifying module 215 verifies the delivery response using a unique public key of a public and private key pair. The verifying module 215 informs the result i.e., success or failure of the verification of the delivery response to the transceiver module 213.

The generating module 217 generates a session key for establishing a secure communication between the UAV 113 and the server 111 for transportation upon receiving the acknowledgement from the UAV 113.

The comparing module 219 compares the UAV 113 battery charge level and the threshold battery charge level (or the amount of energy required to reach the destination location) in the delivery response. The comparing module 219 informs the result i.e., if the UAV battery charge level is higher than or equal to the threshold battery charge level (or the amount of energy required to reach the destination location) or if the UAV battery charge level is lower than the threshold battery charge level (or the amount of energy required to reach the destination location) to the transceiver module 213.

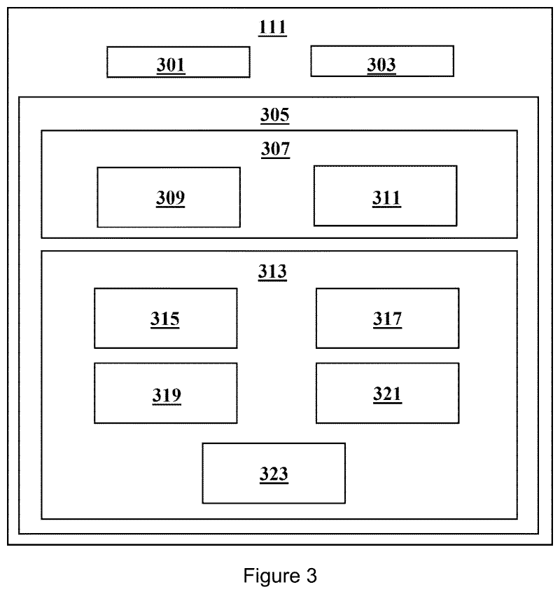

FIG. 3 shows a detailed block diagram of a server in accordance with some embodiments of the present disclosure.

The server 111 includes an I/O interface 301, a processor 303 and a memory 305. The I/O interface 301 is configured to communicate with the user terminal 101 and the UAV 113. The I/O interface 301 may employ communication protocols/methods such as, without limitation, audio, analog, digital, monaural, Radio Corporation of America (RCA) connector, stereo, IEEE® 1394 high speed serial bus, serial bus, Universal Serial Bus (USB), infrared, Personal System/2 (PS/2) port, Bayonet Neill Concelman (BNC) connector, coaxial, component, composite, Digital Visual Interface (DVI), High Definition Multimedia Interface (HDMI®), Radio Frequency (RF) antennas, S Video, Video Graphics Array (VGA), IEEE® 802.11b/g/n/x, Bluetooth, cellular e.g., Code Division Multiple Access (CDMA), High Speed Packet Access (HSPA+), Global System for Mobile communications (GSM®), Long Term Evolution (LTE®), Worldwide interoperability for Microwave access (WiMax®), Aircraft Data Network (ARINC664), or the like.

The processor 303 includes at least one data processor for establishing a secured communication for the UAV 113 in the integrated ecosystem.

The memory 305 is communicatively coupled to the processor 303 of the server 111. The memory 305, also, stores processor instructions which cause the processor 303 to execute the instructions for establishing a secured communication for the UAV 113 in the integrated ecosystem.

The server 111, in addition to the I/O interface 301 and the processor 303 described above, includes data 307 and one or more modules 313, which are described herein in detail. In an embodiment, the data 307 is stored within the memory 305. The data 307 includes, for example, delivery request data 309, and other data 311.

The delivery request data 309 includes delivery request, which comprises at least one of a privilege access level request to operate in public spaces, a UAV identifier, a destination location, user specific information and a type of cargo to be delivered.

The other data 311 may store data, including temporary data and temporary files, generated by one or more modules 313 for performing the various functions of the server 111.

In an embodiment, the data 307 in the memory 305 is processed by the one or more modules 313 present within the memory 305 of the server 111. In an embodiment, the one or more modules 313 may be implemented as dedicated hardware units. As used herein, the term module refers to an Application Specific Integrated Circuit (ASIC), an electronic circuit, a Field Programmable Gate Arrays (FPGA), Programmable System on Chip (PSoC), a combinational logic circuit, and/or other suitable components that provide the described functionality. In some implementations, the one or more modules 313 are communicatively coupled to the processor 303 for performing one or more functions of the server 111. The one or more modules 313 when configured with the functionality defined in the present disclosure will result in a novel hardware.

In one implementation, the one or more modules 313 include, but are not limited to, a transceiver module 315, a verifying module 317, a preparing module 319, and an encrypting module 321. The one or more modules 313, also, include other modules 323 to perform various miscellaneous functionalities of the server 111.

The transceiver module 315 acts as a transmitting module and a receiving module. The transceiver module 315 transmits and receives through the I/O interface 301. The transceiver module 315 receives a delivery request from the user terminal 101. The transceiver module 315 transmits the delivery response to the user terminal 101.

The verifying module 317 verifies the delivery request with at least one of UAV related information and user related information stored in the server 111. The verifying module 317 informs failure of the verification of the delivery request to the transceiver module 213. For instance, in case of a delivery request verification failure due to mismatch of at least one the UAV identifier and the user specific information in the delivery request with at least one of the UAV related information and the user related information stored in the server 111, the verifying module 317 may terminate present process by sending an authentication failure notification or an error message to the transceiver module 315 to transmit to user terminal 101. The verifying module 317 informs success of the verification of the delivery request to the preparing module 319.

The preparing module 319 prepares a delivery response for the delivery request upon (successful) verification. For preparing the delivery response, the preparing module 319 performs one or more, but not limited to, of the following operations: analyzing current traffic, determining a schedule of departure, determining an efficient path from a source location to a destination location, determining alternative routes from the source location to the destination location, determining an altitude of operation of the UAV 113, determining a threshold battery charge level or an amount of energy required to reach the destination location, determining a maximum and minimum speed of the UAV 113 to reach from the source location to the destination location, providing a signature for verification by the UAV 113 and providing a random number to permit a privilege access level request to operate in public spaces.

The encrypting module 321 encrypts the delivery response using a unique private key of a public and private key pair. In detail, the encrypting module 321 transforms the delivery response to a format that is not transparent to attackers or hackers using a private key algorithm. The private key algorithm is an asymmetric cryptographic algorithm, or a quantum cryptographic algorithm.

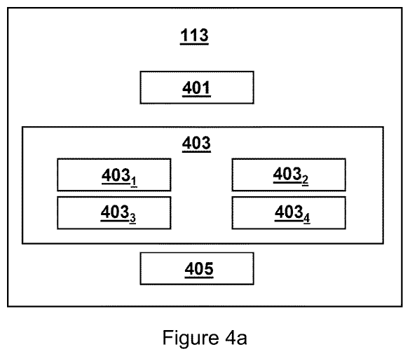

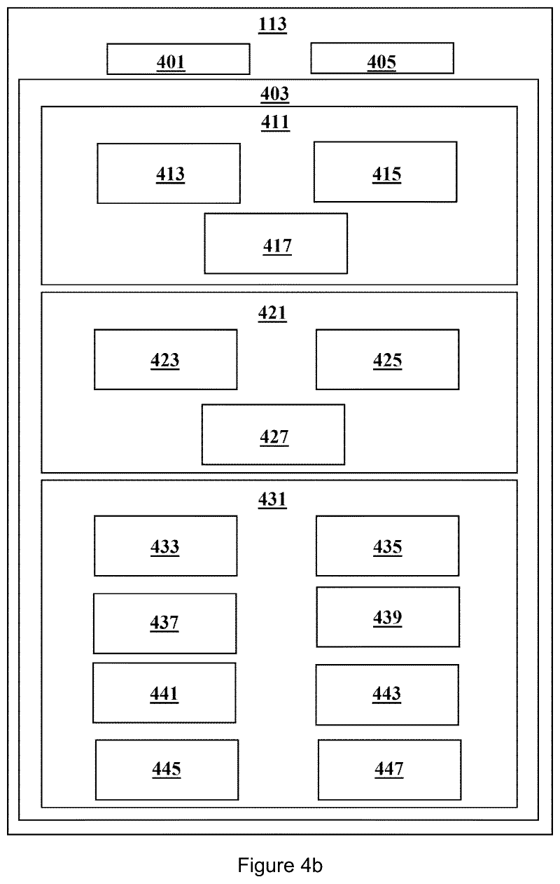

FIGS. 4a and 4b show a detailed block diagram of a UAV in accordance with some embodiments of the present disclosure.

The UAV 113 includes an I/O interface 401, a memory 403, and a processor 405. The I/O interface 401 is configured to communicate with the user terminal 101 and the server 111. The I/O interface 401 may employ communication protocols/methods such as, without limitation, audio, analog, digital, monaural, Radio Corporation of America (RCA) connector, stereo, IEEE® 1394 high speed serial bus, serial bus, Universal Serial Bus (USB), infrared, Personal System/2 (PS/2) port, Bayonet Neill Concelman (BNC) connector, coaxial, component, composite, Digital Visual Interface (DVI), High Definition Multimedia Interface (HDMI®), Radio Frequency (RF) antennas, S Video, Video Graphics Array (VGA), IEEE® 802.11b/g/n/x, Bluetooth, cellular e.g., Code Division Multiple Access (CDMA), High Speed Packet Access (HSPA+), Global System for Mobile communications (GSM®), Long Term Evolution (LTE®), Worldwide interoperability for Microwave access (WiMax®), Aircraft Data Network (ARINC664), or the like.

The processor 405 includes at least one data processor for establishing a secured communication for the UAV 113 in the integrated ecosystem.

The memory 403 is communicatively coupled to the processor 405 of the UAV 113. The memory 403, also, stores processor instructions which cause the processor 405 to execute the instructions for establishing a secured communication for the UAV 113 in the integrated ecosystem. The memory 403 comprises four partitions: a first partition 4031, a second partition 4032, a third partition 4033, and a fourth partition 4034. The first partition 4031 of the memory 403 and the second partition 4032 of the memory 403 both are associated with the first privilege access level, the third partition 4033 of the memory 403 is associated with a second privilege access level, and the fourth partition 4034 of the memory 403 is associated with a third privilege access level. The privilege access level is defined as follows:
To access a higher level of privilege from a lower level of privilege, authentication is required from the server 111. The authentication may be performed using the public and private key pair. For instance, to move from the first privilege access level to the second privilege access level or the third privilege access level requires authentication.
To move or transition to the first privilege access level from the second privilege access level or from the third privilege access level requires no authentication. In this case, the operation is limited to the first privilege access level.
To move or transition to the third privilege access level to the second privilege access level requires authentication.

For authentication, in one embodiment, the signature in the delivery response is verified by the UAV 113 using a unique public key of a public and private key pair stored in the UAV 113. In another embodiment, the signature and the random number in the delivery response are verified by the UAV 113 using a unique public key of a public and private key pair stored in the UAV 113.

The 4 partitions of the memory 403 i.e., the first partition 4031, the second partition 4032, the third partition 4033, and the fourth partition 4034 along with their respective privilege access levels form a (memory) configuration of the UAV 113. Each partition comprises one or more applications required for operation of the UAV 113.

The memory 403 including four partitions are configured in such a way that different mode of operations or different applications of the UAV 113 are accommodated. In detail, the first partition 4031 comprises a bootloader program for starting or booting the UAV 113, the second partition 4032 comprises one or more user-defined applications, the third partition 4033 comprises one or more transportation applications, and the fourth partition 4034 comprises one or more applications for emergency usage. The user defined applications comprise applications or firmware that operates the UAV 113 for controlling height of the UAV 113, reading gyroscope sensor(s), defining rotation of a motor in the UAV 113, and the like. Under emergency usage, the UAV 113 is allowed higher altitude than usual or standard altitude and is allowed to use arbitrary route. The situation may comprise rescuing, delivery medical facilities, and monitoring incidents during emergency. The fourth partition has highest level of privilege access level among the four partitions.

In one embodiment, the first partition 4031 comprising the bootloader program is stored in the memory 403 of the UAV 113 whereas the second partition 4032, the third partition 4033, and the fourth partition 4034 are stored in an external memory (not shown in FIGS. 4a and 4b) of the UAV 113. In the present disclosure, the memory 403 of the UAV 113 is an internal memory. In this embodiment, the memory 403 including the first partition 4031 and the external memory including the second partition 4032, the third partition 4033, and the fourth partition 4034 are configured in such a way that different mode of operations of the UAV 113 are accommodated.

The UAV 113, in addition to the I/O interface 401 and the processor 405 described above, includes data 411 and one or more modules 421, 431, which are described herein in detail. In an embodiment, the data 411 is stored within the memory 403. The data 411 includes, for example, delivery response data 413, session key data 415, and other data 417.

The delivery response data 413 includes delivery response, which comprises at least one of a schedule of departure, an efficient path from a source location to the destination location, alternative routes from the source location to the destination location, an altitude of operation of the UAV 113, the threshold battery charge level or an amount of energy required to reach the destination location, a maximum and minimum speed of the UAV 113 to reach from the source location to the destination location, a signature for verification by the UAV 113 and a random number to permit the privilege access level request to operate in public spaces.

The session key data 415 includes a session key for establishing a secure communication between the UAV 113 and the server 111 for transportation.

The other data 417 may store data, including temporary data and temporary files, generated by one or more modules 421, 431 for performing the various functions of the UAV 113.

In an embodiment, the data 411 in the memory 403 is processed by the one or more modules 421, 431 present within the memory 403 of the UAV 113. In an embodiment, the one or more modules 421, 431 may be implemented as dedicated hardware units. As used herein, the term module refers to an Application Specific Integrated Circuit (ASIC), an electronic circuit, a Field Programmable Gate Arrays (FPGA), Programmable System on Chip (PSoC), a combinational logic circuit, and/or other suitable components that provide the described functionality. In some implementations, the one or more modules 421, 431 are communicatively coupled to the processor 405 for performing one or more functions of the UAV 113. The one or more modules 421, 431 when configured with the functionality defined in the present disclosure will result in a novel hardware.

In one implementation, the one or more modules 421 include, but are not limited to, a transceiver module 423, and a verifying module 425. The one or more modules 421, also, include other modules 427 to perform various miscellaneous functionalities of the UAV 113. In another implementation, the one or more modules 431 include, but are not limited to, a root of trust module 433, a security mechanism module 435, a communication module 437, a sensor module 439, a navigation module 441, an emergency operation module 443, a diagnostic services module 445, and a route path module 447. Each of the 4 partitions of the memory 403 i.e., the first partition 4031, the second partition 4032, the third partition 4033, and the fourth partition 4034 comprise the one or more modules 431 whereas the one or more modules 421 are common to all 4 partitions of the memory 403.

The transceiver module 423 acts as a transmitting module and a receiving module. The transceiver module 423 transmits and receives through the I/O interface 401. The transceiver module 423 transmits a UAV battery charge level to the user terminal 101 upon receiving a request from the user terminal 101. The transceiver module 423 receives a delivery response from the user terminal 101. The transceiver module 423 transmits an acknowledgement to the delivery response upon verifying the signature. The transceiver module 423 receives a session key from the user terminal 101 for establishing a secure communication between the UAV 113 and the server 111 for transportation.

The verifying module 425 verifies a signature in the delivery response using the unique public key of the public and private key pair. The verifying module 425 informs failure of the verification of the signature to the transceiver module 423. For instance, in case of the delivery response verification failure due to mismatch of the signature in the delivery response with the unique public of the public and private key pair of the UAV 113, the verifying module 425 may terminate present process by sending an authentication failure notification or an error message to the transceiver module 423 to transmit to user terminal 101. The verifying module 425 informs success of the verification of the delivery response to the transceiver module 423 to transmit to user terminal 101.

The root of trust module 433 stores (or is configured to store) a hashed value of the unique public key of the public and private key pair. The root of trust module 433 uses the hash function-based algorithm to hash the unique public key. Thereafter, the root of trust module 433 stores the hashed public key. The root of trust module 433 is, also, referred as e-Fuse component. In addition to the unique public key, a UAV identifier (also, referred as UAV related information) and a diagnostic identifier are, also, stored in the root of trust module securely using the hash function-based algorithm. The root of trust module has write and read protections, which prevents any tampering. The diagnostic Identifier is a unique code or value that is used to authenticate before performing a diagnostic activity on the UAV 113. The diagnostic activity comprises activities such as one or more applications or firmware check by concerned authority, updating an application or a firmware to a new application or a firmware version, fixing problem in the application or the firmware, and fixing a bug or an error in the UAV 113. The security mechanism module 435 provides (or is configured to provide) security to the UAV 113 from at least one of malicious attack, tampering, sniffing, and spoofing during the secure communication with the server 111. The security mechanism module 435 uses the session key received from the user terminal 101 for establishing a secure communication between the UAV 113 and the server 111 for transportation.

The communication module 437 handles (or is configured to handle) communication protocol with the server 111 and the user terminal 101 through the I/O interface 401 of the UAV 113.

The sensor module 439 measures (or is configured to measure) an altitude of the UAV 113 and sends (or is configured to send) information related to the altitude to the processor 405 for processing.

The navigation module 441 determines (or is configured to determine) location co-ordinates of the UAV 113 and sends (or is configured to send) the location co-ordinates of the server 111 and the user terminal 101 to the processor 405 for processing.

The emergency operation module 443 sends (or is configured to send) a request to the processor 405 to fly at the altitude assigned for the third privilege access level than the altitude assigned for the second privilege access level during an emergency situation and defines (or is configured to define) a new route to a destination location.

The diagnostic services module 445 allows (or is configured to allow) inspection of the processor 405 or the UAV 113 after verification using the unique public key of the public and private key pair stored in the UAV 113 and updates (configured to update) one or more software of the UAV 113.

The route path module 447 defines (or is configured to define) a route path for the UAV 113 based on an efficient path received in the delivery response. The route path module 447 is present only for the third partition 4033, and the fourth partition 4034 of the memory 403.

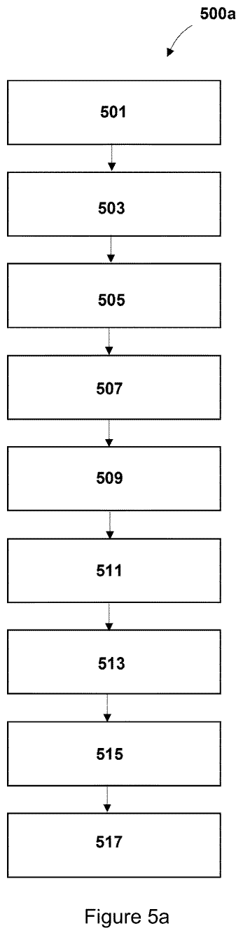

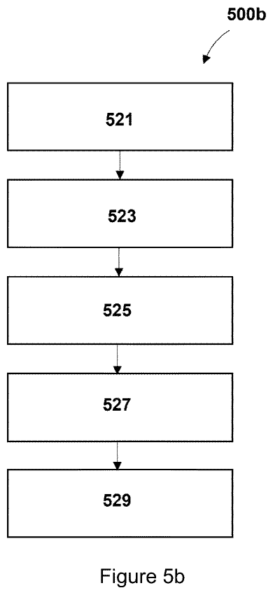

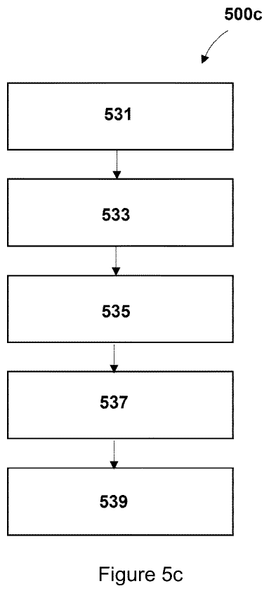

FIGS. 5a, 5b and 5c illustrate flowcharts showing a method for establishing a secured communication for a UAV in an integrated ecosystem performed by a user terminal, a server, and a UAV, respectively, in accordance with some embodiments of present disclosure.

As illustrated in FIGS. 5a, 5b and 5c, the methods 500a, 500b and 500c include one or more blocks for establishing a secured communication for the UAV 113 in an integrated ecosystem. The methods 500a, 500b and 500c may be described in the general context of computer executable instructions. Generally, computer executable instructions can include routines, programs, objects, components, data structures, procedures, modules, and functions, which perform particular functions or implement particular abstract data types.

The order in which the methods 500a, 500b and 500c are described is not intended to be construed as a limitation, and any number of the described method blocks can be combined in any order to implement the method.

Additionally, individual blocks may be deleted from the methods without departing from the scope of the subject matter described herein. Furthermore, the method can be implemented in any suitable hardware, software, firmware, or combination thereof.

The below blocks refer to operations performed by the user terminal 101 for establishing a secured communication for the UAV 113 in an integrated ecosystem.

At block 501, the transceiver module 213 of the user terminal 101 transmits a delivery request to the server 111. The delivery request comprises at least one of a privilege access level request to operate in public spaces, a UAV identifier, a destination location, user specific information and a type of cargo to be delivered.

At block 503, the transceiver module 213 of the user terminal 101 receives a delivery response from the server 111 in response to the delivery request. The delivery response comprises at least one of a schedule of departure, an efficient path from a source location to the destination location, alternative routes from the source location to the destination location, an altitude of operation of the UAV 113, the threshold battery charge level or an amount of energy required to reach the destination location, a maximum and minimum speed of the UAV 113 to reach from the source location to the destination location, a signature for verification by the UAV 113 and a random number to permit the privilege access level request to operate in public spaces.

At block 505, the verifying module 215 of the user terminal 101 verifies the delivery response using a unique public key of a public and private key pair.

At block 507, the transceiver module 213 of the user terminal 101 transmits a request to the UAV 113 to share a UAV battery charge level upon verification of the delivery response

At block 509, the transceiver module 213 of the user terminal 101 receives the UAV battery charge level from the UAV 113.

At block 511, the transceiver module 213 of the user terminal 101 transmits the delivery response to the UAV 113 based on the UAV battery charge level and a threshold battery charge level received in the delivery response.

At block 513, the transceiver module 213 of the user terminal 101 receives an acknowledgement to the delivery response.

At block 515, the generating module 217 of the user terminal 101 generates a session key for establishing a secure communication between the UAV 113 and the server 111 for transportation upon receiving the acknowledgement.

At block 517, the transceiver module 213 of the user terminal 101 transmits the session key to the UAV 113.

The below blocks refer to operations performed by the server 111 for establishing a secured communication for the UAV 113 in an integrated ecosystem.

At block 521, the transceiver module 315 of the server 111 receives a delivery request from the user terminal 101.

At block 523, the verifying module 317 of the server 111 verifies the delivery request with at least one of UAV-related information and user-related information stored in the server 111.

At block 525, the preparing module 319 of the server 111 prepares a delivery response for the delivery request upon verification. The delivery response comprises at least one of a schedule of departure, an efficient path from a source location to a destination location, alternative routes from the source location to the destination location, an altitude of operation of the UAV 113, a threshold battery charge level or an amount of energy required to reach the destination location, a maximum and minimum speed of the UAV 113 to reach from the source location to the destination location, a signature for verification by the UAV 113 and a random number to permit a privilege access level request to operate in public spaces.

At block 527, the encrypting module 321 of the server 111 encrypts the delivery response using a unique private key of a public and private key pair.

At block 529, the transceiver module 315 of the server 111 transmits the delivery response to the user terminal 101.

The below blocks refer to operations performed by the UAV 113 for establishing a secured communication for the UAV 113 in an integrated ecosystem.

At block 531, the transceiver module 423 of the UAV 113 transmits a UAV battery charge level to the user terminal 101 upon receiving a request from the user terminal 101.

At block 533, the transceiver module 423 of the UAV 113 receives a delivery response from the user terminal 101.

At block 535, the verifying module 425 of the UAV 113 verifies a signature in the delivery response using a unique public key of a public and private key pair.

At block 537, the transceiver module 423 of the UAV 113 transmits an acknowledgement to the delivery response upon verifying the signature.

At block 539, the transceiver module 423 of the UAV 113 receives a session key from the user terminal 101 for establishing a secure communication between the UAV 113 and the server 111 for transportation. Thereafter, the transceiver module 423 of the UAV 113 establishes the secure communication with the server 111 using the session key.

Some of the technical advantages of the present disclosure are listed below.

In present disclosure, prior to establishing secure communication between a UAV and a server, communication including request and/or response is exchanged between a user terminal, the server and the UAV is authenticated or verified using a public and private key pair unique to the user terminal, the server and the UAV. This approach ensures enhanced security to prevent configuration tampering in the UAV to bypass the permission to use public space and/or man-in-the middle attack.

The use of a session key from a user terminal for establishing a secure communication between a UAV and a server for transportation ensures that communication between the UAV and the server is aligned appropriately and securely with the parameters exchanged between the user terminal, the server and the UAV. This approach ensures enhanced security (for secured communication) to prevent denial-of-service attack and spoofing communication to the server of faking a UAV path.

The delivery response prepared by a server of the present disclosure ensures information or parameters such as a schedule of departure, an efficient path from a source location to a destination location, alternative routes from the source location to the destination location, an altitude of operation of the UAV, a threshold battery charge level or an amount of energy required to reach the destination location, a maximum and minimum speed of the UAV to reach from the source location to the destination location, a signature for verification by the UAV and a random number to permit a privilege access level request to operate in public spaces. This approach ensures UAV traffic (i.e., traffic management) is handled in an efficient and easy way, thereby, regulating the use of UAV in a safe and secured manner (by concerned authorities).

The user terminal of the present disclosure performs transmitting a delivery response to a UAV based on the UAV battery charge level and a threshold battery charge level. This approach allows user terminal to ensure that the UAV battery charge level is at an appropriate level for the UAV to reach destination location and not fail during the travel from a source location to the destination location due to lack of the UAV battery charge.

The user terminal, the server, and the UAV of the present disclosure work/co-ordinate together to form an integrated ecosystem that has secured communication in terms of encryption and/or verification (i.e., authentication), and efficient and easy way to manage UAV traffic (i.e., traffic management), thereby, making such ecosystem integrable with an ecosystem of smart city.

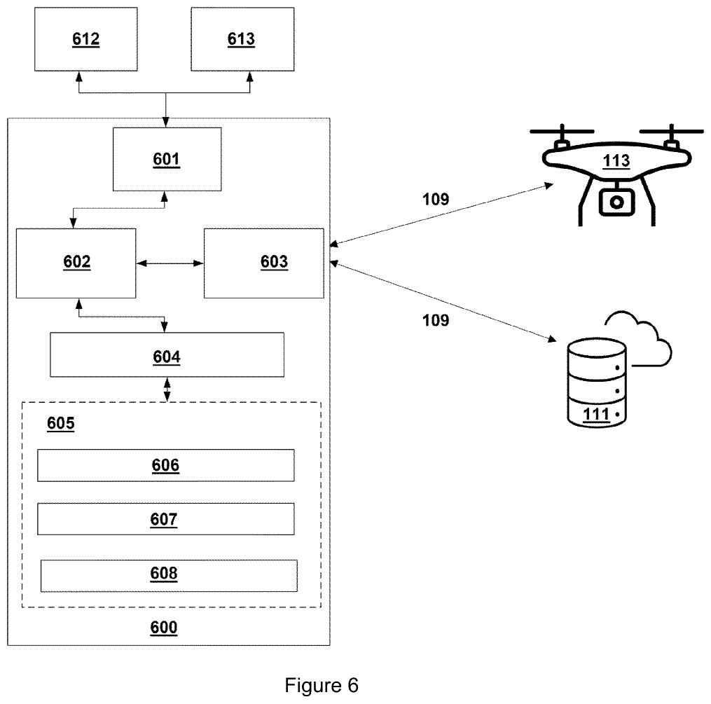

FIG. 6 illustrates a block diagram of an exemplary computer system for implementing embodiments consistent with the present disclosure.

In an embodiment, the computer system 600 is used to implement the user terminal 101. The computer system 600 includes a central processing unit (“CPU” or “processor”) 602. The processor 602 includes at least one data processor for establishing a secured communication for the UAV 113 in an integrated ecosystem. The processor 602 includes specialized processing units such as, integrated system (bus) controllers, memory management control units, floating point units, graphics processing units, digital signal processing units, and the like.

The processor 602 is disposed in communication with one or more input/output (I/O) devices (not shown in FIG. 6) via I/O interface 601. The I/O interface 601 employs communication protocols/methods such as, without limitation, audio, analog, digital, monaural, Radio Corporation of America (RCA) connector, stereo, IEEE® 1394 high speed serial bus, serial bus, Universal Serial Bus (USB), infrared, Personal System/2 (PS/2) port, Bayonet Neill Concelman (BNC) connector, coaxial, component, composite, Digital Visual Interface (DVI), High Definition Multimedia Interface (HDMI®), Radio Frequency (RF) antennas, S Video, Video Graphics Array (VGA), IEEE® 802.11b/g/n/x, Bluetooth, cellular e.g., Code Division Multiple Access (CDMA), High Speed Packet Access (HSPA+), Global System for Mobile communications (GSM®), Long Term Evolution (LTE®), Worldwide interoperability for Microwave access (WiMax®), Aircraft Data Network (ARINC664), or the like.

Using the I/O interface 601, the computer system 600 communicates with one or more I/O devices such as input devices 612 and output devices 613. For example, the input devices 612 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, and the like. The output devices 613 may be a printer, fax machine, video display (e.g., Cathode Ray Tube (CRT), Liquid Crystal Display (LCD), Light Emitting Diode (LED), plasma, Plasma Display Panel (PDP), Organic Light Emitting Diode display (OLED) or the like), audio speaker and the like.

In some embodiments, the computer system 600 consists of the user terminal 101. The processor 602 is disposed in communication with the communication network 109 via a network interface 603. The network interface 603 communicates with the communication network 109. The network interface 603 employs connection protocols including, without limitation, direct connect, Ethernet (e.g., twisted pair 10/100/1000 Base T), Transmission Control Protocol/Internet Protocol (TCP/IP), token ring, IEEE® 802.11a/b/g/n/x and the like. The communication network 109 includes, without limitation, a direct interconnection, Local Area Network (LAN), Wide Area Network (WAN), wireless network (e.g., using Wireless Application Protocol), the Internet, cellular network, Aircraft Data Network (ARINC664), and the like. Using the network interface 603 and the communication network 109, the computer system 600 communicates with the server 111 and the UAV 113. The network interface 603 employs connection protocols that include, but not limited to, direct connect, Ethernet (e.g., twisted pair 10/100/1000 Base T), Transmission Control Protocol/Internet Protocol (TCP/IP), token ring, IEEE® 802.11a/b/g/n/x and the like.

The communication network 109 includes, but is not limited to, a direct interconnection, a Peer to Peer (P2P) network, Local Area Network (LAN), Wide Area Network (WAN), wireless network (e.g., using Wireless Application Protocol), the Internet, Wi Fi, cellular network, Aircraft Data Network (ARINC664), and the like.

In some embodiments, the processor 602 is disposed in communication with a memory 605 (e.g., RAM, ROM, and the like not shown in FIG. 6) via a storage interface 604. The storage interface 604 connects to memory 605 including, without limitation, memory drives, removable disc drives and the like, employing connection protocols such as, Serial Advanced Technology Attachment (SATA), Integrated Drive Electronics (IDE), IEEE® 1394, Universal Serial Bus (USB), fiber channel, Small Computer Systems Interface (SCSI), Universal Asynchronous Receiver/Transmitter (UART), Serial Peripheral Interface (SPI), Quad Serial Peripheral Interface (QSPI), Inter-Integrated Circuit (I2C), and the like. The memory drives further include a drum, magnetic disc drive, magnetooptical drive, optical drive, Redundant Array of Independent Discs (RAID), solid state memory devices, solid state drives, and the like.

The memory 605 stores a collection of program or database components, including, without limitation, user interface 606, an operating system 607 and the like. In some embodiments, computer system 600 stores user/application data, such as, the data, variables, records, and the like, as described in this disclosure. Such databases may be implemented as fault tolerant, relational, scalable, secure databases such as Oracle or Sybase.

The operating system 607 facilitates resource management and operation of the computer system 600. Examples of operating systems include, without limitation, APPLE® MACINTOSH® OS X®, UNIX®, UNIX like system distributions (e.g., BERKELEY SOFTWARE DISTRIBUTION® (BSD), FREEBSD®, NETBSD®, OPENBSD and the like), LINUX® DISTRIBUTIONS (E.G., RED HAT®, UBUNTU®, KUBUNTU® and the like), IBM®OS/2®, MICROSOFT® WINDOWS® (XP®, VISTA®/7/8, 10 and the like), APPLE® IOS®, GOOGLE™ ANDROID™, BLACKBERRY® OS, AUTOSAR™ classic platform, AUTOSAR™ adaptive platform, LINUX® SE, AUTOSAR™ Green Hills platform, QNX OS, or the like.

In some embodiments, the computer system 600 implements web browser 608 stored program components. Web browser 608 is a hypertext viewing application, such as MICROSOFT® INTERNET EXPLORER®, GOOGLE™ CHROME™, MOZILLA® FIREFOX®, APPLE® SAFARI® and the like. Secure web browsing is provided using Secure Hypertext Transport Protocol (HTTPS), Secure Sockets Layer (SSL), Transport Layer Security (TLS) and the like. Web browsers 608 utilizes facilities such as AJAX, DHTML, ADOBE® FLASH®, JAVASCRIPT®, JAVA®, Application Programming Interfaces (APIs) and the like. The computer system 600 implements a mail server (not shown in FIG. 6) stored program component. The mail server is an Internet mail server such as Microsoft Exchange, or the like. The mail server utilizes facilities such as ASP, ACTIVEX®, ANSI®) C++/C#, MICROSOFT®, .NET, CGI SCRIPTS, JAVA®, JAVASCRIPT®, PERL®, PHP, PYTHON®, WEBOBJECTS® and the like. The mail server utilizes communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. The computer system 600 implements a mail client (not shown in FIG. 6) stored program component. The mail client is a mail viewing application, such as APPLE® MAIL, MICROSOFT® ENTOURAGE®), MICROSOFT® OUTLOOK®, MOZILLA® THUNDERBIRD® and the like.

Furthermore, one or more computer readable storage media may be utilized in implementing embodiments consistent with the present disclosure. A computer readable storage medium refers to any type of physical memory on which information or data readable by a processor may be stored. Thus, a computer readable storage medium stores instructions for execution by one or more processors, including instructions for causing the processor(s) to perform steps or stages consistent with the embodiments described herein. The term “computer readable medium” should be understood to include tangible items and exclude carrier waves and transient signals, i.e., be non-transitory. Examples include Random Access Memory (RAM), Read Only Memory (ROM), volatile memory, non-volatile memory, hard drives, CD ROMs, DVDs, flash drives, disks, and any other known physical storage media.

The described operations may be implemented as a method, an individual unit, system, or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape and the like), optical storage (CD ROMs, DVDs, optical disks and the like), volatile and non-volatile memory devices (e.g., EEPROMs, ROMs, PROMs, RAMs, DRAMs, SRAMs, Flash Memory, firmware, programmable logic and the like) and the like. Further, non-transitory computer readable media include all computer readable media except for a transitory. The code implementing the described operations may further be implemented in hardware logic (e.g., an integrated circuit chip, Programmable Gate Array (PGA), Application Specific Integrated Circuit (ASIC) and the like).

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIGS. 5a, 5b and 5c show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the scope being indicated by the following claims.

REFERRAL NUMERALS

| Reference number | Description |
|---|---|
| 100 | Environment |
| 101 | User terminal |
| 103 | I/O interface |
| 105 | Memory |
| 107 | Processor |
| 109 | Communication network |
| 111 | Server |
| 113 | UAV |
| 201 | Data |
| 203 | Delivery response data |
| 205 | UAV battery charge level |
| 207 | Other data |
| 211 | One or more modules |
| 213 | Transceiver module |
| 215 | Verifying module |
| 217 | Generating module |
| 219 | Comparing module |
| 221 | Other modules |
| 301 | I/O interface |
| 303 | Processor |
| 305 | Memory |
| 307 | Data |
| 309 | Delivery request data |
| 311 | Other data |
| 313 | One or more modules |
| 315 | Transceiver module |
| 317 | Verifying module |
| 319 | Preparing module |
| 321 | Encrypting module |
| 323 | Other modules |
| 401 | I/O interface |
| 403 | Memory |
| 403₁ | First partition |
| 403₂ | Second partition |
| 403₃ | Third partition |
| 403₄ | Fourth partition |
| 405 | Processor |
| 411 | Data |
| 413 | Delivery response data |
| 415 | Session key data |
| 417 | Other data |
| 421, 431 | One or more modules |
| 423 | Transceiver module |
| 425 | Verifying module |
| 427 | Other modules |
| 433 | Root of trust module |
| 435 | Security mechanism module |
| 437 | Communication module |
| 439 | Sensor module |
| 441 | Navigation module |
| 443 | Emergency operation module |
| 445 | Diagnostic services module |
| 447 | Route path module |
| 600 | Computer system |
| 601 | I/O interface |
| 602 | Processor |
| 603 | Network interface |
| 604 | Storage interface |
| 605 | Memory |
| 606 | User interface |
| 607 | Operating system |
| 608 | Web browser |
| 612 | Input devices |
| 613 | Output devices |

1. A method for establishing a secured communication for an Unmanned Aerial Vehicle (UAV) in an integrated ecosystem, the method comprising:
transmitting, by a user terminal, a delivery request to a server;
receiving, by the user terminal, a delivery response from the server in response to the delivery request;
verifying, by the user terminal, the delivery response using a unique public key of a public and private key pair;
transmitting, by the user terminal, a request to the UAV to share a UAV battery charge level upon verification of the delivery response;
receiving, by the user terminal, the UAV battery charge level from the UAV;
transmitting, by the user terminal, the delivery response to the UAV based on the UAV battery charge level and a threshold battery charge level received in the delivery response;
receiving, by the user terminal, an acknowledgement to the delivery response;
generating, by the user terminal, a session key for establishing a secure communication between the UAV and the server for transportation upon receiving the acknowledgement; and
transmitting, by the user terminal, the session key to the UAV.

2. The method of claim 1, wherein the delivery request comprises at least one of a privilege access level request to operate in public spaces, a UAV identifier, a destination location, user specific information and a type of cargo to be delivered, and
wherein the delivery response comprises at least one of a schedule of departure, an efficient path from a source location to the destination location, alternative routes from the source location to the destination location, an altitude of operation of the UAV, the threshold battery charge level or an amount of energy required to reach the destination location, a maximum and minimum speed of the UAV to reach from the source location to the destination location, a signature for verification by the UAV and a random number to permit the privilege access level request to operate in public spaces.

3. The method of claim 1, comprising:
comparing, by the user terminal, the UAV battery charge level and the threshold battery charge level in the delivery response; and
transmitting, by the user terminal, the delivery response to the UAV when the UAV battery charge level is higher than or equal to the threshold battery charge level.

4. A method for establishing a secured communication for an Unmanned Aerial Vehicle (UAV) in an integrated ecosystem, the method comprising:
receiving, by a server, a delivery request from a user terminal;
verifying, by the server, the delivery request with at least one of UAV-related information and user-related information stored in the server;
preparing, by the server, a delivery response for the delivery request upon verification;
encrypting, by the server, the delivery response using a unique private key of a public and private key pair; and
transmitting, by the server, the delivery response to the user terminal.

5. The method of claim 4, wherein the delivery response comprises at least one of a schedule of departure, an efficient path from a source location to a destination location, alternative routes from the source location to the destination location, an altitude of operation of the UAV, a threshold battery charge level or an amount of energy required to reach the destination location, a maximum and minimum speed of the UAV to reach from the source location to the destination location, a signature for verification by the UAV and a random number to permit a privilege access level request to operate in public spaces.

6. The method of any of claim 4, prior to receiving the delivery request from the user terminal, the method comprising:
generating, by the server, the public and private key pair using a cryptographic algorithm;
storing, by the server, the unique private key of the public and private key pair in the server; and
transmitting, by the server, a unique public key of the public and private key pair to the UAV and the user terminal.

7. A method for establishing a secured communication for an Unmanned Aerial Vehicle (UAV) in an integrated ecosystem, the method comprising:
transmitting, by the UAV, a UAV battery charge level to a user terminal upon receiving a request from the user terminal;
receiving, by the UAV, a delivery response from the user terminal;
verifying, by the UAV, a signature in the delivery response using a unique public key of a public and private key pair;
transmitting, by the UAV, an acknowledgement to the delivery response upon verifying the signature; and
receiving, by the UAV, a session key from the user terminal for establishing a secure communication between the UAV and a server for transportation.

8. The method of claim 7 further comprising:
establishing, by the UAV, the secure communication with the server using the session key.

9. A user terminal for establishing a secured communication for an Unmanned Aerial Vehicle (UAV) in an integrated ecosystem, the user terminal comprising:
a processor; and
a memory communicatively coupled to the processor, wherein the memory stores processor-executable instructions, which on execution, cause the processor to:
transmit a delivery request to a server;
receive a delivery response from the server in response to the delivery request;
verify the delivery response using a unique public key of a public and private key pair;
transmit a request to the UAV to share a UAV battery charge level upon verification of the delivery response;
receive the UAV battery charge level from the UAV;
transmit the delivery response to the UAV based on the UAV battery charge level and a threshold battery charge level received in the delivery response;
receive an acknowledgement to the delivery response;
generate a session key for establishing a secure communication between the UAV and the server for transportation upon receiving the acknowledgement; and
transmit the session key to the UAV.

10. The user terminal of claim 9, wherein the delivery request comprises at least one of a privilege access level request to operate in public spaces, a UAV identifier, a destination location, user specific information and a type of cargo to be delivered, and
wherein the delivery response comprises at least one of a schedule of departure, an efficient path from a source location to the destination location, alternative routes from the source location to the destination location, an altitude of operation of the UAV, the threshold battery charge level or an amount of energy required to reach the destination location, a maximum and minimum speed of the UAV to reach from the source location to the destination location, a signature for verification by the UAV and a random number to permit the privilege access level request to operate in public spaces.

11. The user terminal of any of claim 9, wherein the processor is configured to:
compare the UAV battery charge level and the threshold battery charge level in the delivery response; and
transmit the delivery response to the UAV when the UAV battery charge level is higher than or equal to the threshold battery charge level.

12. A server for establishing a secured communication for an Unmanned Aerial Vehicle (UAV) in an integrated ecosystem, the server comprising:
a processor; and
a memory communicatively coupled to the processor, wherein the memory stores processor-executable instructions, which on execution, cause the processor to:
receive a delivery request from a user terminal;
verify the delivery request with at least one of UAV-related information and user-related information stored in the server;
prepare a delivery response for the delivery request upon verification;
encrypt the delivery response using a unique private key of a public and private key pair; and
transmit the delivery response to the user terminal.

13. The server of claim 12, wherein the delivery response comprises at least one of a schedule of departure, an efficient path from a source location to a destination location, alternative routes from the source location to the destination location, an altitude of operation of the UAV, a threshold battery charge level or an amount of energy required to reach the destination location, a maximum and minimum speed of the UAV to reach from the source location to the destination location, a signature for verification by the UAV and a random number to permit a privilege access level request to operate in public spaces.

14. The server of claim 12, prior to receiving the delivery request from the user terminal, wherein the processor is configured to:
generate the public and private key pair using a cryptographic algorithm;
store the unique private key of the public and private key pair in the server; and
transmit a unique public key of the public and private key pair to the UAV and the user terminal.

15. An Unmanned Aerial Vehicle (UAV) in an integrated ecosystem comprising:
a processor; and
a memory communicatively coupled to the processor, wherein the memory stores processor-executable instructions, which on execution, cause the processor to:
transmit a UAV battery charge level to a user terminal upon receiving a request from the user terminal;
receive a delivery response from the user terminal;
verify a signature in the delivery response using a unique public key of a public and private key pair;
transmit an acknowledgement to the delivery response upon verifying the signature; and
receive a session key from the user terminal for establishing a secure communication between the UAV and a server for transportation.

16. The UAV of claim 15, wherein the processor is configured to:
establish the secure communication with the server using the session key.

17. The UAV of claim 15, wherein the memory of the UAV comprises a first partition associated with a first privilege access level, a second partition associated with the first privilege access level, a third partition associated with a second privilege access level and a fourth partition associated with a third privilege access level.

18. The UAV of claim 17, wherein the first partition comprises a bootloader program, the second partition comprises one or more user-defined applications, the third partition comprises one or more transportation applications and the fourth partition comprises one or more applications for emergency usage.

19. The UAV of claim 15, wherein the UAV further comprises at least one of:
a root of trust module configured to store a hashed value of the unique public key; and
a security mechanism module configured to provide security using the session key to the UAV from at least one of malicious attack, tampering, sniffing, and spoofing during the secure communication with the server.
